(19) United States
(12) Patent Application Publication
(10) Pub. No.: US 2025/0052899 A1
(43) Pub. Date: Feb. 13, 2025

(54) RELIABLE OPTICAL TRANSIT TIME METHOD FOR DETERMINING DISTANCE VALUES

(71) Applicant: K.A. Schmersal Holding GmbH & Co. KG, Wuppertal (DE)

(72) Inventors: Christian UHLENBROCK, Schwerte (DE); Johannes NEIDHART, Odenthal (DE); Yu-Ru HUANG, New Taipei City (TW); Sheldon Heng Wei CHANG, Taoyuan City (TW)

(21) Appl. No.: 18/722,532

(22) PCT Filed: Dec. 6, 2022
(86) PCT No.: PCT/EP2022/084647

§ 371 Date: Jun. 20, 2024

(30) Foreign Application Priority Data
Dec. 21, 2021 (DE) 10 2021 134 150.7

(51) Int. Cl. G01S 17/36; G01S 17/04; G01S 17/894; G01S 17/931

(52) U.S. Cl. CPC G01S 17/36; G01S 17/04; G01S 17/894; G01S 17/931

(57) ABSTRACT

In a method and an optical time-of-flight sensor for determining distance values d, dᵢ by an optical time-of-flight method, an illumination light 40 is emitted which is modulated with a modulation frequency f and a modulation phase q. Reflected light 42 is acquired as an output signal Rx and evaluated by acquisition of a phase shift δ between the illumination light 40 and the reflected light 42, so that an output signal d, dᵢ with at least one distance value d is generated. Distance values d, dᵢ are determined for a sequence of successive frames, with a plurality of acquisitions being made in each frame in the form of micro-frames μF1-μF8 with different modulation phases φ. A sequence of modulation phases φ₁-φ₄ of the micro-frames μF1-μF8 is specified for each frame. In order to achieve a particularly high reliability of the data supplied, the order of the modulation phases φ₁-φ₄ changes. A self-calibration and self-verification take place in an initialization step (60). The subsequent data acquisition takes place in frame acquisition steps 62 with acquisition of signals and calculation and output of the distance values for each pixel for subsequent processing (68). Each step (62) in the acquisition of a frame is divided into a setup step (64) and a subsequent acquisition of signals in micro-frames μF1-μF8. In setup step (64), the central processing unit MCU calculates (pseudo-)random numbers and uses these to determine the order of the micro-frames μF1-μF8, i.e. the respective modulation frequencies f and phase angles φ. Optical time-of-flight methods, in which the acquisition and signal evaluation are carried out with a variable order of modulation phases, are thus particularly suitable for safety-related applications, e.g. as optical area monitoring systems for industrial production facilities.

### CROSS-REFERENCE TO RELATED APPLICATIONS

This application is the U.S. national phase under 35 U.S.C. 371 of International Application No. PCT/EP2022/084647 filed Dec. 6, 2022, which claims priority to Germany patent application number 10 2021 134 150.7 filed Dec. 21, 2021, the disclosures of which are incorporated herein by reference in their entirety.

### FIELD OF THE INVENTION

The invention relates to a method for determining distance values using a time-of-flight method and an optical time-of-flight sensor for determining distance values.

### BACKGROUND OF THE INVENTION

Optical time-of-flight methods for determining distance values involve the emitting of illumination light and the acquisition of reflected light as well as the evaluation of a delay between illumination light and reflected light caused by the time-of-flight. These cameras are based on the known ToF (time-of-flight) measuring principle, with which not only an image with the reflected intensity and/or color of the pixels is determined for a number of pixels, but also distance values using the time-of-flight method.

DE 10 2019 131 988 A1 describes a 3D time-of-flight camera and a method for the acquisition of three-dimensional image data. An illumination unit emits transmission light that is modulated with a first modulation frequency. An image sensor with a plurality of receiving elements generates received signals from which sampled values are obtained by demodulation at the first modulation frequency. A control and evaluation unit controls the illumination unit and/or demodulation unit for a number of measurement repetitions, each with a different phase offset between the first modulation frequency for the transmitted light and the first modulation frequency for the demodulation. A distance value is determined from the sample values obtained from the measurement repetitions for each light-receiving element. The control and evaluation unit is designed to change the number of measurement repetitions.

DE 10 2013 207 654 A1 discloses a method for operating a time-of-flight camera system in which a distance value is determined based on phase shifts of an emitted and received signal. The phase shifts are determined in two successive phase measurement cycles. Each phase measurement cycle is performed with at least two phase positions, wherein at least two of the phase positions used have a different modulation frequency.

DE 10 2013 207 649 A1 discloses a time-of-flight camera system and a method for operating such a system. In a distance measurement, a first distance-relevant variable is determined using a phase shift of an emitted and received signal for a first modulation frequency. In a control measurement, a second distance-relevant quantity is determined, wherein the control measurement is performed with a second modulation frequency that differs from the first modulation frequency. The control measurement is carried out with a smaller number of phase positions than the distance measurement.

The use of optical time-of-flight sensors such as ToF cameras in safety-critical applications requires a high level of reliability of the data supplied. In safety technology applications in which optical time-of-flight sensors are used to detect objects or people in a hazardous area (e.g. to safeguard the operation of a machine such as an industrial robot or for a vehicle), the proper functioning of the acquisition and evaluation of the distance values by the time-of-flight sensor is crucial.

### SUMMARY OF THE INVENTION

It can be regarded as an object to propose an optical time-of-flight method and an optical time-of-flight sensor for determining distance values in which a particularly high reliability of the data supplied can be achieved by the mode of operation.

The object is solved by a method and an optical time-of-flight sensor. Dependent claims relate to advantageous embodiments of the invention.

In the method according to the invention or by the time-of-flight sensor according to the invention, an illumination light is emitted which is modulated with a modulation frequency and modulation phase. Reflected light is acquired as a received signal and the received signal is evaluated by determination of a phase shift between the illumination light and the reflected light, so that an output signal with at least one distance value is generated. Preferably, distance values for a plurality of pixels are acquired separately from one another, e.g. by an image sensor with a matrix-like arrangement of pixels.

Distance values are determined continuously in a sequence of successive determination steps, which are referred to as frames. In each frame, a distance value (or, in the preferred case of several pixels, a distance value for each of these pixels) is determined.

According to the invention, a plurality of acquisitions are made within each frame in the form of micro-frames, i.e. modulated illumination light is emitted for each micro-frame and the reflected light is evaluated by determining the phase shift. The micro-frames differ in terms of their deviating modulation phase and, potentially in addition, also in terms of their deviating modulation frequency.

For each frame, a sequence of modulation phases (and, potentially in addition, additionally of modulation frequencies) of the micro-frames is specified. The method according to the invention and the device according to the invention are characterized in that the temporal order of the modulation phases (and, potentially in addition of modulation frequencies) used successively for individual acquisitions in the micro-frames of a frame is variable.

This can—preferably—mean a change in the order of the modulation phases (and, potentially in addition of modulation frequencies) for each new frame, so that the sequences of micro-frames of successive frames always differ from one another. However, it is also possible that a specified sequence of modulation phases (and possibly also of modulation frequencies) of the micro-frames is maintained for a contiguous group of two or more immediately successive frames before the sequence changes for a subsequent contiguous group of frames.

The size of the groups, i.e. the number of immediately successive frames with the same sequence, can be suitably selected depending on the frame rate and the desired response time—i.e. depending on the requirements for the acceptable delay before a fault is detected as described below. The group size should be as limited as possible in order to detect faults promptly. According to these considerations, the group size can be up to a maximum of 100, for example, or even more if the requirements are very low. However, smaller groups of a maximum of 10, particularly preferably a maximum of 5 or even only 1-3 frames per group, are preferred-especially for a fast response time. If, for example, the frame rate is in the range of approx. 100 FPS, a good response time of 50 ms can still be achieved with a group size of 5, for example.

When analyzing the acquisition and evaluation in a sequence of micro-frames with different modulation phases, the inventors here found that an unexpected change in the modulation phase has a significant and characteristic influence on the determined phase shift between illumination light and reflected light and thus on the determined distance value. As will be explained in detail below, an unexpected deviation of the modulation phase can affect the distance values of all pixels as an additive term, while a deviation of the modulation frequency can have a multiplicative effect, i.e. as a factor, on the distance values of all pixels.

In the event of a deviation between the modulation frequencies and/or modulation phases used for the various micro-frames, characteristic and thus easily detectable signal deviations result-especially when processing several pixels which are all affected in the same way. For this reason, an optical time-of-flight method and an optical time-of-flight sensor, in which the order of the modulation phases of the micro-frames is variable according to the invention, proves to be extremely sensitive, so that malfunctions can be detected quickly. It is therefore easy to verify correct functioning by monitoring the signal supplied by the time-of-flight sensor. However, the values supplied by the time-of-flight sensor can still be used, i.e. verification can be carried out using the useful signal supplied by the time-of-flight sensor.

Optical time-of-flight methods and optical time-of-flight sensors, in which the acquisition and signal evaluation are carried out according to the principle of the invention with a variable order of modulation phases, are thus particularly suitable for safety-related applications.

According to the invention, verification is carried out by comparing values calculated from the phase shift, e.g. distance values, of at least two successive frames which have a mutually deviating order of the modulation phases (and, potentially in addition of the modulation frequencies) of the micro-frames. As already explained, in the event of unexpected deviations in the modulation, characteristic deviations in the resulting distance value occur. If the different sequence of micro-frames is not applied correctly when the modulated illumination light is emitted or when the received signal is evaluated, deviations will occur in the values calculated from the phase shift, e.g. distance values. By comparing values of successive frames with different sequences of micro-frames, such malfunctions can be detected by recognizing the characteristic deviations and thus a corresponding malfunction. The frames whose values are compared with each other can follow each other in immediate succession, but the frames on which the comparison is based can also be spaced apart by a certain amount in time and other frames can also be acquired in the meantime.

Preferably, the order of the modulation phases (and, potentially the modulation frequencies) of the micro-frames changes for each frame or each contiguous group of frames compared to the immediately preceding frame or the immediately preceding contiguous group of frames. This enables continuous verification of the control and signal evaluation.

The values calculated from the phase shift, e.g. distance values, can be compared using various calculation methods, in particular by forming a difference and/or a ratio of the successive values. The values calculated from the phase shift can be compared directly with each other or characteristic values can first be calculated from the values and then compared. The calculation of characteristic values can, for example, in the preferred case of the acquisition of a plurality of pixels, be performed as the formation of a sum or an average value over several or all values calculated from the phase shift acquired within a frame. While the use of values of all pixels acquired within a frame is possible, in many cases a meaningful statement can also be made by evaluating the values of only a part of the pixels, for example less than half of the pixels, which simplifies processing. If only values of some of the pixels are used, it is preferable that these pixels are spaced apart and, for example, evenly distributed over the sensor surface. According to a preferred further development, it can be provided that only those pixels are taken into account in the comparison for which valid distance values or distance values at or below a maximum distance value are present within at least one, preferably both, of the frames under consideration. If no objects are present in certain image areas within the measuring range of the sensor, a comparison for the pixels located in these image areas will allow no or only a limited meaningful statement. It may therefore be preferable to limit the formation of the characteristic values in both frames to be compared to those pixels for which a measured value is available (or for which it is below a maximum threshold at or below the maximum range).

According to a further development of the invention, the modulation phases of two micro-frames within a frame are preferably directly in phase opposition to each other, i.e. have a phase difference of 180° to each other. If at least two signal contributions from opposite-phase micro-frames are processed for a frame during signal evaluation, these can preferably be subtracted from each other. Subtraction can eliminate or at least reduce interference.

As the determination of distance values is based on a phase comparison between the modulated illumination light and the reflected light, ambiguities arise in the case of transit times that result in a phase difference of more than 360°. To resolve such ambiguities, modulation frequencies that deviate from each other can be used. It is therefore preferable to process at least two signal contributions from micro-frames with different modulation frequencies when determining a distance value for a frame. The ambiguity distance when using two different modulation frequencies then corresponds to the smallest common multiple of the two modulation frequencies.

The sequence of the micro-frames, i.e. the sequence of the modulation phases (and, potentially in addition of the modulation frequencies) of the respective micro-frames, can be suitably selected for each frame or each contiguous group of frames, for example according to a specified sequence determined by a calculation rule or by pre-stored values, for example in the form of a table. Particularly preferably, for each frame or each contiguous group of frames, the order of the modulation phases (and, potentially in addition the modulation frequencies) of the micro-frames can be selected by a (pseudo-) random generator. By using random sequences, constant repetitions and patterns are excluded, so that a particularly reliable verification can take place.

### BRIEF DESCRIPTION OF THE DRAWINGS

In the following, embodiments of the invention are described in more detail with reference to drawings. They show:

FIG. 1 a schematic representation of a first example of a system for monitoring the operation of an industrial plant by means of a time-of-flight sensor;

FIG. 2 a schematic representation of how the time-of-flight sensor from FIG. 1 works;

FIG. 3 a schematic representation of elements of the time-of-flight sensor from FIG. 1, FIG. 2;

FIG. 4a, 4b time response diagrams of a reference signal, transmitted signal and received signal with different modulation phases;

FIG. 5 curves over time of useful and interference signals to explain the combination of inverse signals;

FIG. 6 a diagram showing geometric relationships between signal processing variables;

FIG. 7 a flow chart for signal acquisition

FIG. 8 a schematic, perspective view of a second example of a system for monitoring a hazardous area of a vehicle with a time-of-flight sensor.

### DETAILED DESCRIPTION OF EMBODIMENTS

In various areas, e.g. industrial production facilities, protective devices are used, for example, to protect people from the dangers of production processes or to protect the production process from disturbances. In addition to or instead of guards, contactless, in particular optical area monitoring systems are also used, which prove to be particularly advantageous in areas where cooperation between people and machines is necessary.

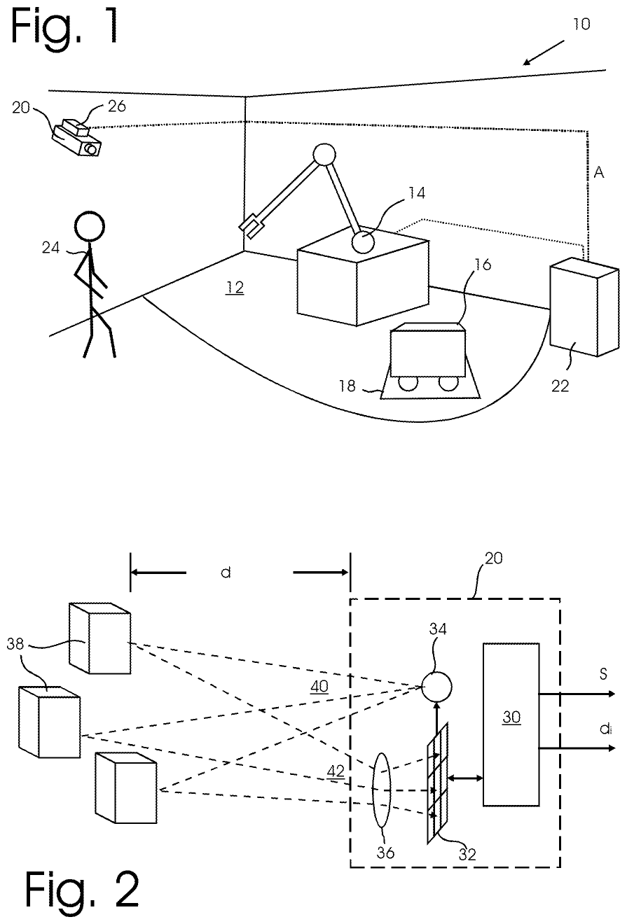

FIG. 1 shows as a first application example a system 10 for monitoring the operation of an industrial plant, here for example comprising an industrial robot 14 and an autonomous industrial truck 16. A safety zone 12 is defined around the industrial robot 14. A control device 22 controls the industrial robot 14 and—via a wireless connection (not shown)—also the industrial truck 16.

For safe operation of the industrial robot 14, no persons 24 may be present within the safety area 12 in the current example. The industrial truck 16 can traverse the safety area 12, for which purpose a mobile cut-out area 18 of the safety area 12 is defined that moves with the industrial truck 16.

In order to implement these safety requirements, an optical monitoring device 20 with a risk assessment unit 26 is mounted stationary in such a way that it optically acquires the industrial robot 14 and its surroundings, i.e. at least the safety area 12.

The control device 22 is coupled to the risk assessment unit 26 of the optical monitoring device 20 and receives an evaluation signal A from it, for example via an OSSD output. As will be explained in more detail below, the evaluation signal A indicates whether or not there is currently a detection of persons or unauthorized objects in the security area 12. The optical monitoring device 20 and the risk assessment unit 26 are designed for safety, i.e. by means of redundancy and self-verification, in such a way that the evaluation signal A only signals a free security area 12 if not only no persons 24 or objects are detected there, but also the proper functioning of the monitoring device 20 is ensured.

As long as the evaluation signal A in the form of an enable signal indicates that the safety area 12 is free and the proper function of the optical monitoring device 20 is also ensured, the control device 22 controls the operation of the machines 14, 16 in accordance with the respective working process.

Persons 24 are not endangered by the first machine 14 as long as they remain or move outside the safety area 12. If the risk assessment unit 26 detects the presence of a person or an object in the safety area 12 from the signals of the optical monitoring device 20, as explained below, and communicates this to the control device 22 by means of a corresponding evaluation signal A in the form of an alarm or warning signal, the control device 22 stops further operation of the machines 14, 16 or places them in a safe state so that persons are protected and collisions with objects are avoided. The same also applies in the event that the evaluation signal A is output as an alarm or warning signal because an internal verification of the optical monitoring device 20 indicates that it is not functioning properly.

The optical monitoring device 20 comprises a time-of-flight sensor, i.e. a ToF (time-of-flight) camera with a control unit 30 which supplies signals dᵢ and S to the risk assessment unit 26. As explained in more detail below, the signal dᵢ is values of the distance d between the optical monitoring device 20 and objects acquired thereby. The signal dᵢ comprises the distance values of a plurality of pixels. The signal S is a safety signal that indicates proper functioning of the optical monitoring device 20.

The risk assessment unit 26 evaluates the distance values dᵢ provided by the optical monitoring device 20 in order to detect persons 24 or objects present in the security area 12. In addition, the optical monitoring device 20 may also supply a conventional 2D camera image, which is also processed by the risk assessment unit 26. Furthermore, the risk assessment unit 26 processes the safety signal S supplied by the optical monitoring device 20. Only if no objects or persons are detected in the safety area 12 after evaluation of the distance values dᵢ (and, if potentially, the 2D image data) and at the same time the safety signal indicates that the optical monitoring device 20 is functioning properly, an enable signal is output as the evaluation signal A, otherwise an alarm or warning signal is output.

The structure and functional principle of the acquisition of distance values dᵢ by the optical monitoring device 20 should be explained with reference to FIG. 2. There, the arrangement of objects 38 in the area acquired by the optical monitoring device 20 is shown schematically, also referred to as field-of-view (FoV). By means of an optical system 36 and a pixel sensor 32, a conventional 2D pixel image of the objects 38 is recorded. In addition, the distances d between the optical monitoring device 20 and the respective objects 38 are determined for each of the pixels of the sensor 32, so that a 3D image is acquired overall.

As shown schematically in FIG. 2, the optical monitoring device 20 comprises, in addition to the optics 36 and the pixel sensor 32, a controlled light source 34 and a control and evaluation unit 30. The control and evaluation unit 30 controls the pixel sensor 32, which in turn controls the light source so 34 that it emits modulated, namely pulsed illumination light 40 according to certain specifying parameters. Reflected light 42 from the objects 38 is received by the pixel sensor 32 and transmitted to the control unit 30 for processing.

The depth measurement, i.e. processing and evaluation of the signals to determine distance values, is based on the time-of-flight of the photons. Due to the short distances and therefore extremely short flight times at the speed of light c, special processing is necessary in order to obtain good measured values for distances d.

The basic principle is as follows: Instead of emission and time measurement based on a single light pulse, a rapid sequence of light pulses is emitted as illumination light 40 by the light source 34, which is preferably formed as a VSCEL (vertical-cavity surface-emitting laser) laser diode. The illumination light 40 corresponds to a pulsed signal Tx with a specific modulation frequency f.

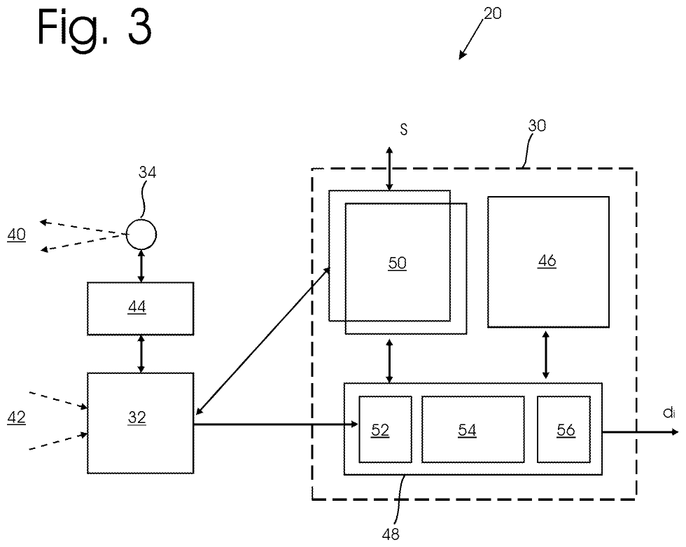

In an advantageous embodiment, the modulation frequency f is specified by the sensor 32. A typical modulation frequency f is, for example, 100 MHz. A corresponding control signal is suitably sent from the sensor 32 to a laser diode driver 44 (see FIG. 3), for example via a low-voltage difference signaling.

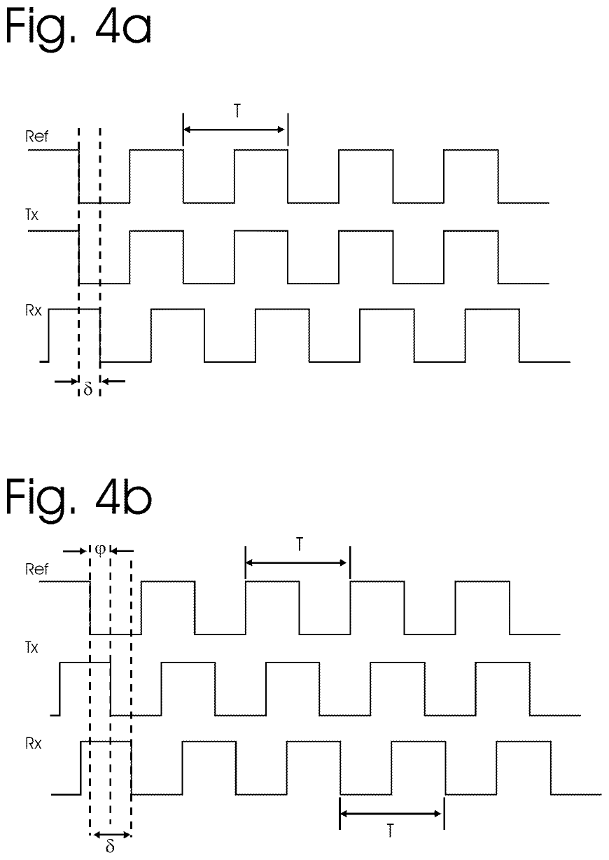

FIG. 4a shows exemplary time curves of a reference signal Ref, a transmitted signal Tx of the light source 34 and a received signal Rx of a pixel. In the idealized representation, these are each rectangular signals. The reference signal Ref with the modulation frequency f and the resulting period duration T=1/f is specified, for example, by the sensor 32.

In the example of FIG. 4a, the transmitted signal Tx, i.e. the modulation of the illumination light 40 of the light source 34, has the same frequency as the reference signal Ref and is in phase with it.

The reflected light 42 is converted into a voltage signal at the sensor 32 in a known manner for each pixel, the acquisition taking place in each case during an integration time and the voltage value of each pixel preferably being converted into a digital value, so that a digital received signal Rx is present.

The received signal Rx received at each pixel of the sensor 32 is also modulated with the modulation frequency f, but is phase-shifted by a phase difference δ compared to the reference signal Ref and transmit signal Tx-due to the time-of-flight.

The corresponding delay time t_{δ} corresponds to

$${}_{δ} t = δ / ( 2 π f ) .$$

The distance d then corresponds to

$$d ( δ ) = 1 / 2 vt = 1 / 2 δ c / ( 2 π f ) ,$$

where the factor ½ is included because the light overcomes the distance d twice.

Due to the periodicity of the modulated signals Tx and Rx, the phase angle δ repeats itself after one period and is therefore limited to the interval [0, 2π]. It is therefore not possible, for example, to distinguish between δ=π/4 and θ=2π+π/4→δ=θ(mod 2ππ)=π/4. In order to achieve uniqueness of the acquisition beyond the uniqueness distance d(2π), successive acquisitions with different modulation frequencies can be made in a known manner and evaluated in combination as explained below.

To improve the quality of the acquired data, the acquisition is advantageously carried out several times in successive micro-frames, whereby a set of distance values, namely one distance value for each pixel, is determined for each successive time period (frame) from the received signals Rx acquired within the micro-frames in combination.

As an example, four micro-frames can be acquired for each modulation frequency. For each micro-frame i in the interval [1 . . . 4], an initial phase angle φᵢ is specified in the interval [0, 2π] as shown in FIG. 4b, i.e. the transmitted signal Tx is output phase-shifted by the phase angle φᵢ in each micro-frame i compared to the reference signal Ref. During signal evaluation, the phase angle φᵢ is also taken into account, i.e. the distance value d is to be calculated as a function of the phase angle φᵢ as

$$d ( δ - {φ}_{i} ) = 1 / 2 ( δ - {φ}_{i} ) c / ( 2 π f ) .$$

During the acquisition of a frame, micro-frames with different phase angles φᵢ are acquired one after the other, with each phase angle φᵢ representing a shift in the measurement, i.e. a phase angle φᵢ between 0 and 360° can result in a shift over the entire measurement range. The decisive factor here is that this affects all pixels in the same way.

The inventors have determined the influence of a phase angle deviating from the expected value φᵢ. In the event that there is a shift in the initial phase angle that was not taken into account in the evaluation, i.e.

$${φ}_{i}^{′} = {φ}_{i} + Δ {φ}_{i} ,$$

this results in a shift Δd in the distance value d′ determined according to the above formula compared to the correct distance value d:

$${d}^{′} = 1 / 2 ( δ - {φ}_{i}^{′} ) c / ( 2 π f ) = d - 1 / 2 Δ {φ}_{i} c / ( 2 π f ) \text{=:} d - Δ d .$$

This shift Δd is global, i.e. all pixels are affected in the same way. If the average value of all distance values dᵢ of the individual pixels is considered as the characteristic value <D>, the result is

$$〈 {D}^{′} 〉 = 〈 D 〉 + Δ d .$$

As already mentioned, the acquisition of distance values dᵢ for each pixel within each frame typically takes place in micro-frames, in which different phase angles φᵢ are specified on the one hand, and different modulation frequencies f on the other, so that ambiguities can be resolved and thus the measurement range can be increased.

With regard to the modulation frequency f, the inventors have also investigated the influence of a possible unexpected deviation of the actually used modulation frequency f′ from the expected modulation frequency f with regard to the modulation frequency f. If, for example, it is assumed that

$$f = α f ,$$

calculating the distance d″ according to the above formula using the expected frequency f gives the following value

$${d}^{″} = 1 / 2 ( δ - {φ}_{i}^{′} ) c / ( 2 π α f ) = d / α ,$$

i.e. a deviation by a deviation factor 1/α from the correct value d. The deviation factor 1/α is also global here, i.e. the distance values of all pixels are equally affected.

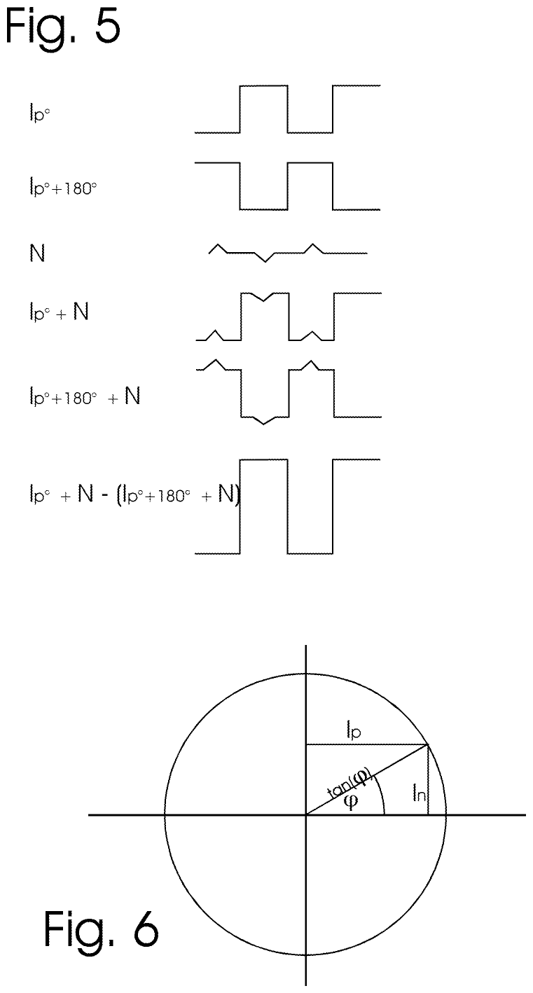

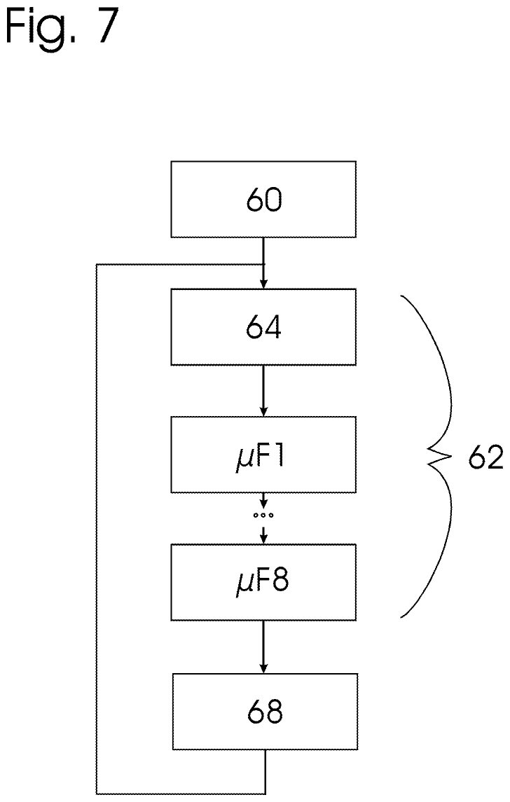

Typically, micro-frames are recorded with pairs of inverse phase angles, i.e. in the above example of four micro-frames, for example, with the phase angles φ₁=0°, φ₂=90°, φ₃=180°, φ₄=270°. Signals from pairs of inverse phase angles (0° and 180° as well as 90° and 270°) are inverse to each other so that any additive interference can be eliminated by subtracting the inverse signals from each other. This is illustrated as an example in FIG. 5 for inverse signals I_{p°} and I_{p°+180°} as well as an additive superimposed interference signal N, which is assumed to be identical for both micro-frames. Subtraction I_{p°}−I_{p°+180°} eliminates the interference signal N here.

In the signal evaluation, the intensities determined in the respective micro-frames are combined for each pixel. In the above example of four micro-frames, these are the signals I_{0°}, I_{90°}, I_{180°}, I_{270°} for each pixel. Inverse signals are subtracted so that the following auxiliary variables are defined

$${I}_{n} = {I}_{0 °} - {I}_{180 °}$$

$${I}_{d} = {I}_{90 °} - {I}_{270 °}$$

$$A = ( {I}_{n} / {I}_{n} ) .$$

Then, as shown in FIG. 6, the following applies for the phase angle φTx,Rx

$${φ}_{Tx , Rx} = {tan}^{- 1} ( A ) ,$$

consequently

$$tan ( {φ}_{Tx , Rx} ) = A .$$

The inventors have also considered the influence of unexpected changes in the phase angle for the above evaluation by combining two inverse signals. If, for example, a change in the 180° phase angle by a change amount x is assumed, this leads to a signal In′ that is changed by a factor β compared to the undisturbed signal In:

$${I}_{n} = {I}_{0 °} - {I}_{180 °} \approx 2 {I}_{0 °} \text{=>} {I}_{n}^{′} + {I}_{0 °} - {I}_{180 ° + x} \approx {I}_{0 °} - β {I}_{180 °} = {I}_{n} ( 1 - β ) .$$

Here, β is a proportional value that is independent of the signal strength, i.e. the same for each pixel. The phase deviation in the micro-frame—here, for example, I_{180°}—results in a value A′ that deviates from the actual value A

A′=γA=γ tan(φ_{Tx,Rx})=tan(φ′_{Tx,Rx}).

In the evaluation, the deviating phase value therefore has an effect in the form of a multiplicative deviation of argument A, so that a deviating distance value d is also determined here.

Since the effects of deviations in the modulation frequency and/or modulation phase are global in each case, i.e. they affect the distance values dᵢ of all pixels in the same way, a deviation can be determined by determining a characteristic value for the distance values dᵢ of all pixels (or of a representative subset thereof), e.g. the sum or the arithmetic mean <D>. In the sequence of values acquired within micro-frames or the distance values dᵢ determined from them in combination for the frame, a deviation can be detected by comparing successive values, e.g. by forming the ratio or the difference of the respective characteristic values, e.g. the arithmetic mean <D>.

For the acquisition of the distance values dᵢ of each frame, a sequence of micro-frames with specific modulation phases and modulation frequencies is specified, e.g. for two modulation frequencies f1 and f2 and four modulation phase angles φ₁=0°, φ₂=90°, φ₃=180°, φ₄=270° according to the following table:

TABLE 1
Frame 1

| No. Micro- | Modulation | modulation |
|---|---|---|
| Frame | frequency | phase angle |
| μF1 | f1 | φ₁ |
| μF2 | f1 | φ₂ |
| μF3 | f1 | φ₃ |
| μF4 | f1 | φ₄ |
| μF5 | f2 | φ₅ |
| μF6 | f2 | φ₆ |
| μF7 | f2 | φ₇ |
| μF8 | f2 | φ₈ |

In order to dynamize both the signal generation and the signal evaluation, the sequence of the micro-frames, i.e. the temporal order of the sets of modulation frequencies and modulation phase angles, is constantly changed. The same micro-frames, i.e. combinations of modulation frequencies and modulation phase angles, are used in each frame, only their time sequence changes, e.g. as follows

TABLE 2
Frame 2

| No. Micro- | Modulation | modulation |
|---|---|---|
| Frame | frequency | phase angle |
| μF1 | f2 | φ₂ |
| μF2 | f1 | φ₄ |
| μF3 | f1 | φ₃ |
| μF4 | f1 | φ₂ |
| μF5 | f2 | φ₄ |
| μF6 | f1 | φ₁ |
| μF7 | f2 | φ₃ |
| μF8 | f2 | φ₁ |

FIG. 3 schematically shows the components of the control and evaluation unit 30 of the optical monitoring device 20, which operates according to the functional principle explained above.

A central unit MCU 50 is designed for safety, i.e. with redundant components with synchronization of the results of the redundant components, e.g. with a lockstep processor or as two redundant MCU central units. The MCU 50 central unit controls the entire optical monitoring device 20 and outputs the safety signal S. The MCU 50 central unit is coupled with a DSP 46 for signal processing.

An FPGA or ASIC 48 comprises as functional units an internal high-speed communication unit 52, e.g. a DSI interface specified according to MIPI, an image processing unit 54 and an input/output unit 56, e.g. as a safety bus, via which the distance signal dᵢ is output.

The mode of operation is explained using the flow chart in FIG. 6. After the start, self-calibration and self-verification take place in an initialization step 60. The subsequent data acquisition takes place in each case in (summarized) frame acquisition steps 62 with—as explained in more detail below-acquisition of signals and calculation and output of the distance values dᵢ for each pixel for subsequent processing (step 68). The frame acquisition 62 and calculation/output of the distance values 68 is constantly repeated.

Each step 62 in the acquisition of a frame is divided into a setup step 64 and a subsequent acquisition of signals in micro-frames μF1-μF8. In setup step 64, the central processing unit MCU 50 calculates (pseudo-) random numbers and uses these to determine the order of the micro-frames μF1-μF8, i.e. the respective modulation frequencies f and phase angles q. The central processing unit MCU 50 sets register values in the sensor 32 according to the randomly determined order of the micro-frames. Further, in the setup step 64, the sensor 32 performs power calibration of the driver 44 by the driver 44 operating the light source (VCSEL) 34 with an initial operating current and optimizing the operating current based on a feedback signal received from the light source 34.

After setup step 64, the acquisition of micro-frames μF1-μF8 takes place in the previously defined order. In each case, the sensor 32 controls the driver 44 with a timing signal Tx based on the data specified for the respective micro-frame, i.e. frequency and phase. The light source 34 is thereby operated and emits pulsed light 40 according to the specified frequency and phase.

Reflected light 42 is received by the sensor 32 as previously explained and converted into a digital signal Rx that is different for each pixel, frequency and phase.

The received signals Rx of each pixel are transmitted to the control and evaluation unit 30, in particular to the internal high-speed communication unit 52, from where they are delivered to the image processing unit 54, in which the distance values dᵢ are determined for each pixel according to the above-mentioned mode of operation. The distance values dᵢ are output by the input/output unit 56 to the risk assessment unit 26 for further processing.

During image processing, the DSP 46 calculates in parallel a characteristic value A as an arithmetic mean for a subset of the distance values dᵢ, e.g. for 5% or 10% thereof, which are spaced apart and distributed over the sensor surface. The characteristic value is calculated for each frame or time point as Aₜ.

The DSP 46 continuously determines a deviation for successive frames by forming the ratio of successive characteristic values Aₜ

$${F}_{t} = {A}_{t} / {A}_{t - 1} .$$

With an unchanged image and correct data acquisition, Fr should always be (exactly or approximately) 1. Due to influences such as noise and, in particular, movements of the acquired objects 38 relative to the optical monitoring device 20, Ft may deviate slightly from 1. A deviation above a maximum deviation value±ΔF, on the other hand, indicates an error, e.g. an incorrectly applied order of micro-frames during signal acquisition or evaluation.

If the ratio Ft is in the interval [1−ΔF, 1+ΔF], the MCU 50 central unit detects the correct function of signal detection and evaluation and issues a corresponding confirmation as safety signal S, otherwise an alarm or warning signal.

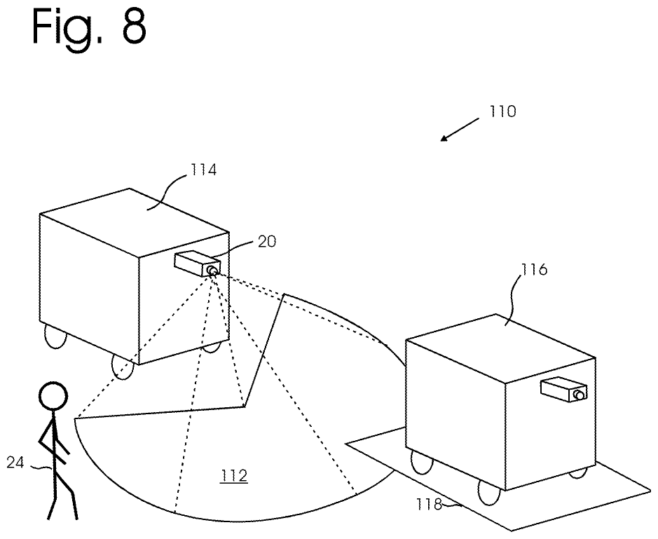

As a second embodiment example, FIG. 8 shows a system 110 for monitoring the operation of two mobile machines 114, 116, which are equipped with optical monitoring devices 20 and each monitor a safety area 112. A cut-out area 118 is excluded from this area. The optical monitoring devices 20 of the vehicles 114, 116 are securely designed as previously described for the optical monitoring device 20 of the system 10 according to the first embodiment example.

In summary, the described embodiments enable devices and methods for determining distance values by means of optical time-of-flight methods, in which dynamization occurs both during signal generation and signal evaluation by changing the order of the micro-frames. By monitoring possible deviations, verification can take place and a high level of reliability can be achieved.

The devices and methods explained above are to be understood as merely exemplary and not limiting, and deviations from the above examples are possible within the scope of protection of the patent claims.

For example, instead of changing the order of micro-frames after each frame, groups of several, e.g. up to 100 frames with the same order of micro-frames can also be acquired before the order is changed. The number of modulation frequencies and phases used can deviate from the examples above. Instead of randomly changing the order, the change can also follow a fixed change scheme.

The evaluation of the distance values to determine whether the supplied 3D image shows an intrusion of a person 24 or an object within the security area 12 can preferably be carried out internally, for example by the MCU 50 central unit designed for security technology, possibly supported by the DSP 46, instead of in a separate risk assessment unit 26 as explained. In this case, no separate risk assessment unit 26 is necessary, but the control and evaluation unit 30 can additionally take over this task with the existing hardware. In any case, it should be pointed out that the naming and presentation of separate components and functional blocks within the embodiment examples and the claims are primarily to be understood functionally and not necessarily in such a way that these must also necessarily be separate hardware components. In fact, various functionalities can be executed on a hardware component such as central processing unit MCU 50 or DSP 46 by means of suitable software.

1. Method for determining distance values by an optical time-of-flight method in which
an illumination light is emitted, modulated with a modulation frequency and a modulation phase,
reflected light is acquired as received signal
and the received signal is evaluated by determining a phase shift between the illumination light and the reflected light, so that an output signal with at least one distance value is generated,
wherein distance values are determined for a sequence of successive frames, wherein in each frame a plurality of acquisitions are made in the form of micro-frames with different modulation phases,
wherein a sequence of modulation phases of the micro-frames is specified for each frame,
and wherein the order of the modulation phases changes
and wherein verification is carried out by comparing values calculated from the phase shift of at least two successive frames that have a mutually deviating order of the modulation phases of the micro-frames.

2. Method according to claim 1, wherein
the micro-frames comprise a sequence of modulation phases and modulation frequencies
wherein the order of the modulation frequencies changes.

3. (canceled)

4. Method according to claim 1, wherein
the values of the successive frames calculated from the phase shift are compared by determining at least one characteristic value for each of the two frames, comparing the two characteristic values and recognizing a fault state in the event of a deviation above a defined threshold or a correct functional state in the event of a deviation below the defined threshold.

5. Method according to claim 1, in which
the values or characteristic values calculated from the phase shift are compared by forming a difference and/or a ratio.

6. Method according to claim 1, wherein
the reflected light is acquired as a received signal for a plurality of pixels,
and an output signal is generated for each pixel by determining a phase shift between the illumination light and the reflected light.

7. Method according to claim 6, wherein
the characteristic values are average values over a plurality of pixels of the two frames.

8. Method according to claim 7, wherein
not all pixels are used when calculating the average values.

9. Method according to claim 1, wherein
when determining a distance value for a frame, at least two signal contributions of micro-frames with modulation phases of a phase difference of 180° are subtracted from each other.

10. Method according to claim 1, wherein
the order of the modulation phases of the micro-frames changes for each frame or each group of frames compared to the immediately preceding frame or the immediately preceding group of frames.

11. Method according to claim 1, wherein
for each frame or group of frames, the order of the modulation phases of the micro-frames are selected by a random generator.

12. Method according to claim 1, wherein
when determining a distance value for a frame, at least two signal contributions from micro-frames with different modulation frequencies are processed to resolve ambiguity.

13. Optical time-of-flight sensor for determining distance values, with
a controllable illumination device designed to emit modulated illumination light with a modulation frequency and a modulation phase,
a receiving device designed to receive reflected light and to provide a received signal,
an evaluation device designed to evaluate the received signal by determining a phase shift between the illumination light and the reflected light and to generate an output signal with distance values,
wherein the evaluation device is further designed to determine distance values for a sequence of successive frames, wherein in each frame a plurality of acquisitions are made in the form of micro-frames with mutually different modulation phases,
and a verification device designed for specifying a sequence of modulation phases of the micro-frames for the illumination device, wherein the order of the modulation phases of the micro-frames changes
wherein the verification device is further designed for comparing values calculated from the phase shift of at least two temporally successive frames which have a mutually deviating order of the modulation phases of the micro-frames.

14. (canceled)
